(19) United States
(12) Patent Application Publication
(10) Pub. No.: US 2023/0207911 A1
(43) Pub. Date: Jun. 29, 2023

(54) BATTERY MODULE HAVING SIMPLE SENSING STRUCTURE

(71) Applicant: LG ENERGY SOLUTION, LTD., Seoul (KR)

(72) Inventors: Hee-Jun JIN, Daejeon (KR); Sung-Won SEO, Daejeon (KR); Yoon-Koo LEE, Daejeon (KR); Jeong-O MUN, Daejeon (KR); Eun-Ah JU, Daejeon (KR)

(73) Assignee: LG ENERGY SOLUTION, LTD., Seoul (KR)

(21) Appl. No.: 18/115,669

(22) Filed: Feb. 28, 2023

Related U.S. Application Data
(63) Continuation of application No. 16/313,637, filed on Dec. 27, 2018, now abandoned.

(30) Foreign Application Priority Data
Mar. 21, 2017 (KR) 10-2017-0035400

(51) Int. Cl. H01M 10/48; H01M 50/105; H01M 50/548; H01M 50/553

(52) U.S. Cl. CPC H01M 10/48; H01M 50/105; H01M 50/548; H01M 50/553; H01M 50/129

(57) ABSTRACT

Disclosed is a battery module, which includes a pouch-type battery cell; a voltage sensor configured to sense a voltage of the battery cell; and a sensing wire configured to connect the battery cell and the voltage sensor, wherein the battery cell includes a sensing lead connected to an electrode tab, and wherein the sensing lead is exposed to the outside through a sensing hole formed in a sealing portion of the pouch cell.

### TECHNICAL FIELD

The present disclosure relates to a battery module having a simple sensing structure, and more particularly, to a battery module capable of minimizing a length of a sensing line in a pouch-type battery cell at which electrode leads are drown in both directions.

The present application is a Continuation of co-pending U.S. patent application Ser. No. 16/313,637, which is a U.S. national stage entry pursuant to 35 U.S.C. § 371, filed on Dec. 27, 2018, of PCT Application No. PCT/KR2018/002145, filed on Feb. 21, 2108, which claims priority to Korean Patent Application No. 10-2017-0035400 filed on Mar. 21, 2017 in the Republic of Korea. The disclosures of each of the above prior U.S., PCT, and Korean patent applications are incorporated herein by reference.

### BACKGROUND ART

In a pouch-type battery cell, if a positive electrode tab and a negative electrode tab are drawn in different directions and thus a positive electrode lead connected to the positive electrode tab and a negative electrode lead connected to the negative electrode tab are also drawn in different directions, a sensing line for sensing a voltage of the battery cell is inevitably elongated very long.

Referring to FIG. 1, a pouch-type battery cell 1 in which a pair of electrode leads 1a, 1b are drown in opposite directions is depicted.

For sensing a voltage of the battery cell 1, the positive electrode lead 1a and the negative electrode lead 1b located at opposite sides should be connected to a voltage sensor 2 by using a sensing wire 3, respectively. Thus, in the bi-directional drawing-type battery cell, the sensing wire 3 inevitably has a very long length.

If the sensing wire 3 has a long length, the complicated sensing structure causes space limitation in the module, and also the sensing wire 3 is more likely to be damaged due to interference with other components.

### DISCLOSURE

### Technical Problem

The present disclosure is designed to solve the problems of the related art, and therefore the present disclosure is directed to providing a structure in which a sensing wire is capable of being installed at only one side of a battery cell to minimize a length of the installed sensing wire and also minimize the possibility of short circuit between a sensing lead for connecting the sensing wire and an electrode lead adjacent thereto.

However, the technical problem to be solved by the present disclosure is not limited to the above, and other objects not mentioned herein will be understood from the following description by those skilled in the art.

### Technical Solution

In one aspect of the present disclosure, there is provided a battery module, comprising: a pouch-type battery cell; a voltage sensor configured to sense a voltage of the battery cell; and a sensing wire configured to connect the battery cell and the voltage sensor, wherein the battery cell includes a sensing lead connected to an electrode tab, and wherein the sensing lead is exposed to the outside through a sensing hole formed in a sealing portion of the pouch cell.

The battery cell may be a bidirectional drawing-type battery cell in which the pair of electrode leads are drawn in opposite directions.

The sensing lead may be located to be adjacent to any one of the pair of electrode leads.

The sensing wire may connect the sensing lead to the voltage sensor and also connect the electrode lead adjacent to the sensing lead to the voltage sensor.

The sensing hole may be formed in an upper or lower surface of the pouch case.

The sensing wire may be connected to the sensing lead by a solder.

The sensing hole may be formed in both of upper and lower surfaces of the pouch case.

A receptacle may be connected to an end of the sensing wire, and the receptacle may be in contact with and elastically presses both surfaces of the sensing lead.

In another aspect of the present disclosure, there is also provided a battery cell, comprising: an electrode assembly having a pair of electrode tabs; a pair of electrode leads connected to the electrode tabs; and a pouch case configured to accommodate the electrode assembly and sealed in a state where the electrode leads are exposed to the outside of the pouch case, wherein the battery cell includes a sensing lead connected to an electrode tab, and wherein the sensing lead is exposed to the outside through a sensing hole formed in a sealing portion of the pouch cell.

The battery cell may be a bidirectional drawing-type battery cell in which the pair of electrode leads are drawn in opposite directions.

The sensing lead may be located to be adjacent to any one of the pair of electrode leads.

The sensing hole may be formed in at least one of upper and lower surfaces of the pouch case.

### Advantageous Effects

According to an embodiment of the present disclosure, since the sensing wire is capable of being installed only at one side of the battery cell, the length of the installed sensing wire may be minimized.

According to another embodiment of the present disclosure, the possibility of short circuit between a sensing lead for connecting the sensing wire and an electrode lead adjacent thereto sensing wire may be minimized.

### DESCRIPTION OF DRAWINGS

The accompanying drawings illustrate a preferred embodiment of the present disclosure and together with the foregoing disclosure, serve to provide further understanding of the technical features of the present disclosure, and thus, the present disclosure is not construed as being limited to the drawing.

FIG. 1 is a diagram showing a conventional sensing structure.

FIG. 2 is a plane view showing a battery module according to an embodiment of the present disclosure.

FIG. 3 is a plane view showing a battery cell employed at the present disclosure.

FIG. 4 is an enlarged view showing a portion A of FIG. 3.

FIG. 5 is a diagram showing an example of the battery cell employed at the present disclosure and is a cross-sectioned view, taken along the line X-X′ of FIG. 3.

FIG. 6 is a diagram showing that a sensing wire is connected to the battery cell depicted in FIG. 5.

FIG. 7 is a diagram showing an embodiment in which a gasket is applied to the battery cell depicted in FIG. 5.

FIG. 8 is a diagram showing another example of the battery cell employed at the present disclosure and is a cross-sectioned view, taken along the line X-X′ of FIG. 3.

FIG. 9 is a diagram showing that a sensing wire is connected to the battery cell depicted in FIG. 8.

FIG. 10 is a diagram showing an embodiment in which a gasket is applied to the battery cell depicted in FIG. 8.

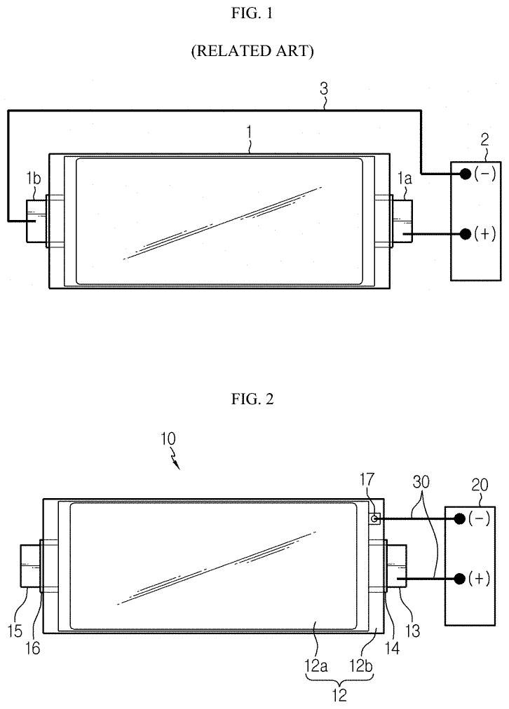

### BEST MODE

Hereinafter, preferred embodiments of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation. Therefore, the description proposed herein is just a preferable example for the purpose of illustrations only, not intended to limit the scope of the disclosure, so it should be understood that other equivalents and modifications could be made thereto without departing from the scope of the disclosure.

The overall configuration of a battery module according to an embodiment of the present disclosure will be described with reference to FIG. 2.

FIG. 2 is a plane view showing a battery module according to an embodiment of the present disclosure.

Referring to FIG. 2, a battery module according to an embodiment of the present disclosure includes a pouch-type battery cell 10, a voltage sensor 20 for sensing a voltage of the battery cell 10, and a sensing wire 30 for electrically connecting a positive electrode and a negative electrode of the battery cell 10 to the voltage sensor 20.

The battery cell 10 employed at the present disclosure is a pouch-type battery cell and includes an electrode assembly 11, a pouch case 12, a pair of electrode leads 13, 15, a pair of sealants 14, 16 and a sensing lead 17.

The electrode assembly 11 is configured so that a positive electrode plate, a separator and a negative electrode plate are stacked at least once, and the separator is preferably located at both outer sides for insulation.

Though not shown in the figures, the positive electrode plate includes a positive electrode current collector and a positive electrode active material layer coated on at least one surface thereof, and a positive electrode uncoated region not coated with the positive electrode active material layer is formed at one end thereof. The positive electrode uncoated region serves as a positive electrode tab 11a connected to the positive electrode lead 13.

Similarly, the negative electrode plate includes a negative electrode current collector and a negative electrode active material layer coated on at least one surface thereof, and an uncoated region not coated with the active material layer is formed at one end thereof. The uncoated region serves as a negative electrode tab 11a connected to the negative electrode lead 15.

In this specification, for example, the electrode lead 13 located at the right in FIG. 2 is called a positive electrode lead, and the electrode lead 15 located at the left is called a negative electrode lead. However, the present disclosure is not limited thereto, and the polarities may be formed on the contrary.

Meanwhile, when being stacked, the positive electrode plate and the negative electrode plate are disposed so that the electrode tabs 11a having different polarities, namely the positive electrode tab and the negative electrode tab, are oriented to opposite sides.

In addition, the separator is interposed between the positive electrode plate and the negative electrode plate to prevent the electrode plates having different polarities from directly contacting, and is made of a porous material to allow ion passage.

The electrode leads 13, 15 are classified into a positive electrode lead 13 connected to the positive electrode tab and a negative electrode lead 15 connected to the negative electrode tab. Since the positive electrode tab and the negative electrode tab are oriented oppositely as described above, the positive electrode lead 13 and the negative electrode lead 15 also extend in opposite directions accordingly.

Meanwhile, the electrode leads 13, 15 are generally made of an aluminum material coated with nickel, and such metallic electrode leads 13, 15 are not easily adhered to an inner surface of the pouch case 12 when the pouch case 12 is sealed.

Thus, in the sealing region of the pouch case 12, a portion where the electrode leads 13, 15 are drawn may have weak sealing. For this reason, in order to improve the sealing property, sealants 14, 16 made of a resin material with good adhesion to the inner surface of the pouch case 12 may be attached to the periphery of the electrode leads 13, 15.

The pouch case 12 may be composed of an upper case and a lower case, and the upper case and the lower case may be respectively made of a multilayered porous film composed of a first resin layer, a metal layer and a second resin layer.

In this case, the first resin layer forming an innermost surface of the pouch film may be made of a resin with a thermal bonding property so that the upper case and the lower case may be easily fused to each other when heat is applied thereto in a state where the upper case and the lower case are in contact.

The pouch case 12 may be classified into two portions, namely an accommodation portion 12a for accommodating the electrode assembly 11 and a sealing portion 12b extending in a circumferential direction of the accommodation portion 12a so that the electrode leads 13, 15 drawn to the outside is thermally fused thereto to seal the pouch case 12.

As described above, in the sealing portion 12b, a region where the electrode leads 13, 15 pass may have weak sealing, and thus the sealants 14, 16 are applied to the corresponding region.

In other words, the sealants 14, 16 are interposed between the inner surfaces of the upper pouch case and the lower pouch case in a state of being attached to the peripheries of the electrode leads 13, 15.

Meanwhile, the battery cell 10 employed at the present disclosure further includes a sensing lead 17 for voltage sensing, in addition to the pair of electrode leads 13, 15. The sensing lead 17 may have positive polarity or negative polarity.

In other words, the sensing lead 17 is located to be adjacent to any one of the positive electrode lead 13 and the negative electrode lead 15. Here, if the sensing lead 17 is located on the sealing portion 12b provided in a side where the positive electrode lead 13 is drawn as shown in FIG. 2, the sensing lead 17 has negative polarity, and if the sensing lead 17 is located in a side where the negative electrode lead 15 contrary to FIG. 2, the sensing lead 17 has positive polarity.

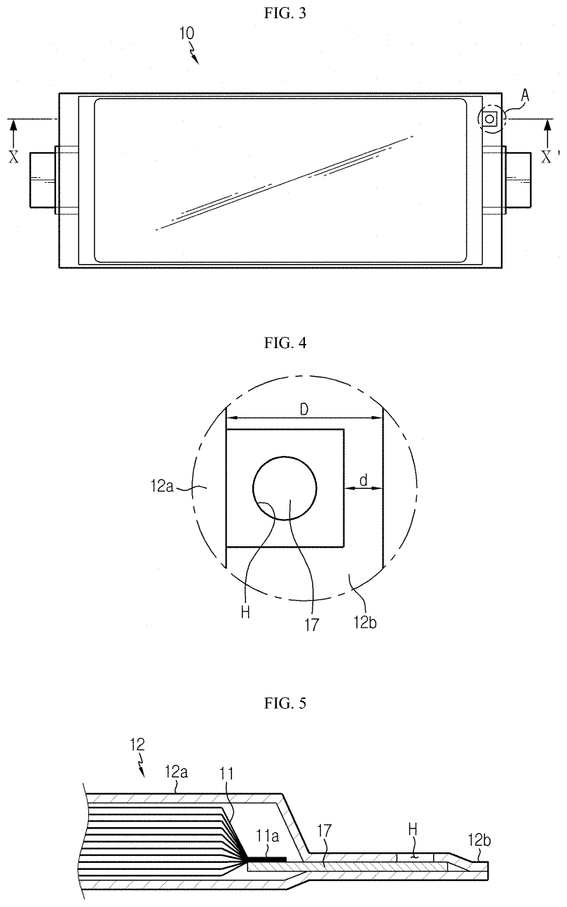

Next, the sensing lead 17 will be described in more detail with reference to FIGS. 3 to 5.

FIG. 3 is a plane view showing a battery cell employed at the present disclosure, and FIG. 4 is an enlarged view showing a portion A of FIG. 3. Also, FIG. 5 is a diagram showing an example of the battery cell employed at the present disclosure and is a cross-sectioned view, taken along the line X-X′ of FIG. 3.

Referring to FIGS. 3 to 5, the sensing lead 17 is a component located at the sealing portion 12b at one side or the other side of the battery cell 10. The sensing lead 17 is bonded to the electrode tab 11a of the electrode assembly 11 and extends in parallel to the positive electrode lead 13 or the negative electrode lead 15 adjacent thereto. However, the sensing lead 17 does not extend to the outside of the pouch case 12 but is located at the inside thereof, and is exposed to the outside through a sensing hole H formed in a part of the sealing portion 12b of the pouch case 12.

Meanwhile, as shown in FIG. 4, in the sealing portion 12b, a region where the sensing lead 17 is located is not sealed. In other words, compared to the entire width D of the sealing portion 12b, a sealing width d of the region where the sensing lead 17 is located is smaller. Here, in order to prevent the sealing property from deteriorating due to the smaller width, the sealing width d of the region where the sensing lead 17 is located is preferably ¼ or above of the entire width D of the sealing portion 12b.

Next, a method for connecting a sensing wire to the battery cell according to an embodiment of the present disclosure will be described with reference to FIGS. 5 to 7.

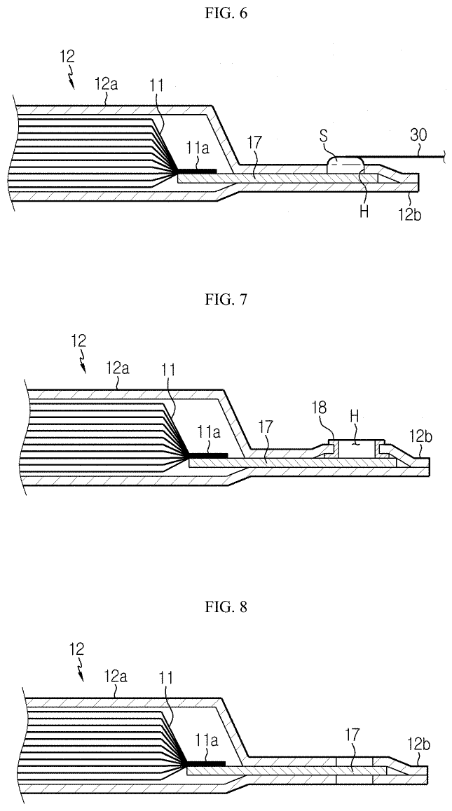

FIG. 6 is a diagram showing that a sensing wire is connected to the battery cell depicted in FIG. 5.

FIG. 7 is a diagram showing an embodiment in which a gasket is applied to the battery cell depicted in FIG. 5.

First, referring to FIGS. 5 and 6, if the sensing hole H is formed only in any one surface of the sealing portion 12b, the sensing wire 30 may be bonded to the sensing lead 17 by using a solder S.

Even though the figures of the present disclosure depict only a case where the sensing hole H is formed in the upper surface of the pouch case 12, the present disclosure is not limited thereto, and the sensing hole H may be formed in the lower surface thereof, instead of the upper surface, if necessary.

Next, referring to FIG. 7, the battery cell 10 employed at the present disclosure may further include a gasket 18 for preventing the sealing property of the pouch case 12 from deteriorating due to the sensing hole H.

The gasket 18 is inserted into an edge of the sensing hole H and is interposed between the sensing lead 17 and the inner surface of the pouch case 12 to seal a region where the sensing hole H is formed.

In addition, the gasket 18 covers the inner wall of the sensing hole H to prevent the metal layer from being exposed to the outside through the inner wall of the sensing hole H, namely a cut surface for forming the sensing hole H, thereby preventing the occurrence of short circuit by the metal layer.

Next, another example of the battery cell employed at the present disclosure and a method for connecting a sensing wire and a sensing lead will be described with reference to FIGS. 8 to 10.

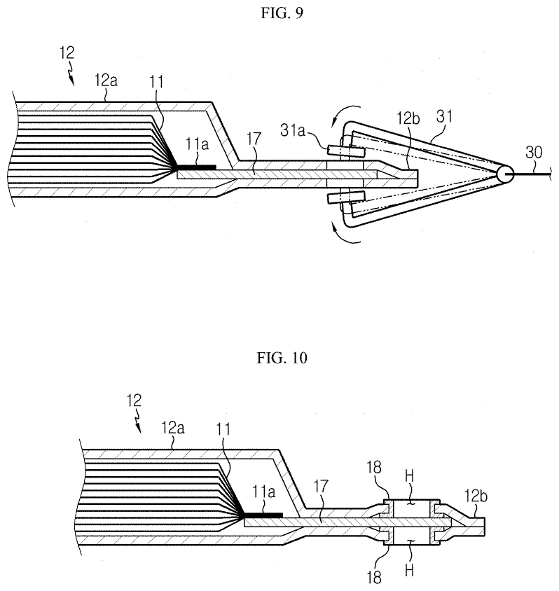

FIG. 8 is a diagram showing another example of the battery cell employed at the present disclosure and is a cross-sectioned view, taken along the line X-X′ of FIG. 3, and FIG. 9 is a diagram showing that a sensing wire is connected to the battery cell depicted in FIG. 8. Also, FIG. 10 is a diagram showing an embodiment in which a gasket is applied to the battery cell depicted in FIG. 8.

First, referring to FIG. 8, the battery cell 10 employed at the present disclosure may have the sensing hole H in both of the upper and lower surfaces of the pouch case 12, different from FIG. 5.

Referring to FIG. 9, if the sensing hole H is formed in both of the upper and lower surfaces of the pouch case 12 as described above, the sensing wire 20 and the sensing lead 17 may be electrically connected by using a receptacle 31.

The receptacle 31 is connected to one end of the sensing wire 30, and a pair of contact portions 31a formed at the end elastically press both surfaces of the sensing lead 17 so that the battery cell 10 and the voltage sensor 20 may be electrically connected in a stable and convenient way. In this case, in order to minimize electric resistance and maximize the coupling force, the contact portion 31a may be shaped and sized to correspond to the sensing hole H.

Meanwhile, referring to FIG. 10, the sensing holes H formed in both surfaces of the pouch case 12 may be sealed by the gasket 18, similar to the embodiment depicted in FIG. 7.

As described above, since the battery module according to an embodiment of the present disclosure includes the sensing lead 17 exposed to the outside through the sealing portion 12b, it is not needed to respectively connect the sensing wire 30 to the electrode leads 13, 15 drawn in opposite directions.

In other words, the battery module according to an embodiment of the present disclosure is configured such that the battery cell 10 and the voltage sensor 20 are electrically connected through the sensing lead 17 and one electrode lead located adjacent to one side of the battery cell 17, and thus has a structural advantage in that the extending length of the sensing wire 30 may be shortened.

The present disclosure has been described in detail. However, it should be understood that the detailed description and specific examples, while indicating preferred embodiments of the disclosure, are given by way of illustration only, since various changes and modifications within the scope of the disclosure will become apparent to those skilled in the art from this detailed description.

What is claimed is:

1. A battery module, comprising:
a pouch-type battery cell, including:
a pouch case including an accommodation portion and a sealing portion extending from a periphery of the accommodating portion, the sealing portion having a sensing hole;
an electrode assembly disposed within the accommodating portion of the pouch case and including a first electrode plate of a first polarity, a separator, and a second electrode plate of a second polarity opposite the first polarity stacked on one another, and an electrode tab connected to the second electrode plate at a first peripheral side of the electrode assembly;
a first electrode lead connected to the first electrode plate and extending outside the pouch case from the first peripheral side of the electrode assembly;
a second electrode lead connected to the second electrode plate and extending outside the pouch case from a second peripheral side of the electrode assembly opposite the first side; and
a sensing lead disposed within the sealing portion of the pouch case and connected to the electrode tab at the first peripheral side of the electrode assembly, the sensing lead being exposed externally through the sensing hole in the sealing portion of the pouch case;
a voltage sensor configured to sense a voltage of the battery cell between the first electrode lead and the sensing lead; and
a sensing wire configured to connect the sensing lead of the battery cell and the voltage sensor.

2. The battery module of claim 1,
wherein the battery cell is a bidirectional drawing-type battery cell in which the first and second electrode leads having opposite polarities are drawn in opposite directions from each other.

3. The battery module of claim 1,
wherein the sensing lead is located adjacent to the first electrode lead at the first peripheral side of the electrode assembly.

4. The battery module of claim 3,
wherein the first electrode lead has a voltage of the first polarity, and the sensing lead has a voltage of the second polarity opposite the first polarity.

5. The battery module of claim 1, further comprising:
another sensing wire configured to connect the voltage sensor with the first electrode lead adjacent to the sensing lead at the first peripheral side of the electrode assembly.

6. The battery module of claim 1,
wherein the sensing hole is a through-hole formed in an upper or lower surface of the sealing portion of the pouch case.

7. The battery module of claim 1,
wherein the sensing hole is formed in both upper and lower surfaces of the sealing portion of the pouch case.

8. The battery module of claim 7,
wherein a receptacle is connected to an end of the sensing wire, and
wherein the receptacle is in contact with and elastically presses both upper and lower surfaces of the sensing lead.

9. The battery module of claim 1,
wherein the electrode assembly further includes at least one other first electrode plate of the first polarity, at least one other separator, and at least one other second electrode plate of the second polarity stacked on one another, and
wherein the electrode tab is further connected to the at least one other second electrode plate at the first peripheral side of the electrode assembly.

10. The battery module of claim 9,
wherein the first electrode lead is further connected to the at least one other first electrode plate, and the second electrode lead is further connected to the at least one other second electrode plate.

11. The battery module of claim 1, further comprising:
a sealant for sealing a region of the pouch case where the first electrode lead or the second electrode lead extends outside the pouch case,
wherein the sealant is attached to the first electrode or the second electrode and is adhered to an inner surface of the pouch case.

12. A battery cell, comprising:
a pouch case including an accommodation portion and a sealing portion extending from a periphery of the accommodating portion, the sealing portion having a sensing hole;
an electrode assembly disposed within the accommodating portion of the pouch case and including:
a first electrode plate of a first polarity, a separator, and a second electrode plate of a second polarity opposite the first polarity stacked on one another; and
an electrode tab connected to the second electrode plate at a first peripheral side of the electrode assembly;
a first electrode lead connected to the first electrode plate and extending outside the pouch case from the first peripheral side of the electrode assembly;
a second electrode lead connected to the second electrode plate and extending outside the pouch case from a second peripheral side of the electrode assembly opposite the first side; and
a sensing lead disposed within the sealing portion of the pouch case and connected to the electrode tab at the first peripheral side of the electrode assembly, the sensing lead being exposed through the sensing hole in the sealing portion of the pouch case.

13. The battery cell of claim 12,
wherein the battery cell is a bidirectional drawing-type battery cell in which the first and second electrode leads having opposite polarities are drawn in opposite directions from each other.

14. The battery cell of claim 12,
wherein the sensing lead is located adjacent to the first electrode lead at the first peripheral side of the electrode assembly.

15. The battery cell of claim 14,
wherein the first electrode lead has a voltage of the first polarity, and the sensing lead has a voltage of the second polarity opposite the first polarity.

16. The battery cell of claim 12,
wherein the sensing hole is a through-hole formed in at least one of upper and lower surfaces of the sealing portion of the pouch case.

17. The battery cell of claim 16,
wherein the sensing hole is formed in both the upper and lower surfaces of the sealing portion of the pouch case.

18. The battery cell of claim 12,
wherein the electrode assembly further includes at least one other first electrode plate of the first polarity, at least one other separator, and at least one other second electrode plate of the second polarity stacked on one another, and
wherein the electrode tab is further connected to the at least one other second electrode plate at the first peripheral side of the electrode assembly.

19. The battery cell of claim 18,
wherein the first electrode lead is further connected to the at least one other first electrode plate, and the second electrode lead is further connected to the at least one other second electrode plate.

20. The battery cell of claim 12, further comprising:
a sealant for sealing a region of the pouch case where the first electrode lead or the second electrode lead extends outside the pouch case,
wherein the sealant is attached to the first electrode or the second electrode and is adhered to an inner surface of the pouch case.
